(19) United States
(12) Patent Application Publication
(10) Pub. No.: US 2020/0349104 A1
(43) Pub. Date: Nov. 5, 2020

(54) CHIP, PROCESSOR, COMPUTER SYSTEM AND MOVABLE DEVICE

(71) Applicant: SZ DJI TECHNOLOGY CO., LTD., Shenzhen (CN)

(72) Inventor: Bin YI, Shenzhen (CN)

(21) Appl. No.: 16/935,746

(22) Filed: Jul. 22, 2020

Related U.S. Application Data
(63) Continuation of application No. PCT/CN2018/073788, filed on Jan. 23, 2018.

(51) Int. Cl. G06F 13/42; G06F 13/40; G06F 11/14

(52) U.S. Cl. CPC G06F 13/4282; G06F 11/1441; G06F 13/4045

(57) ABSTRACT

A chip includes a first subsystem and a second subsystem. The first subsystem includes a first system bus and a first interface of a peripheral bus. The first interface is connected with the first system bus. The second subsystem includes a second system bus and a second interface of the peripheral bus. The second interface is connected with the second system bus.

### CROSS-REFERENCE TO RELATED APPLICATION

This application is a continuation of International Application No. PCT/CN2018/073788, filed on Jan. 23, 2018, the entire content of which is incorporated herein by reference.

### TECHNICAL FIELD

The present disclosure relates to the technical field of information technology and, more particularly, to a chip, a processor, a computer system, and a movable device.

### BACKGROUND

Existing chip designs may involve interconnection and intercommunication of multiple subsystems. A chip may include multiple subsystems, for example, an application processor (AP) subsystem, a media subsystem, a communication subsystem, and a flight control subsystem, etc. These subsystems need to be connected by access channels.

In the current chip designs, buses such as the Advanced High Performance Bus (AHB) or the Advanced eXtensible Interface (AXI) provide accessing functions. For example, when the AP subsystem needs to access the flight control subsystem, the AHB bus of the AP subsystem reserves a master interface and the AHB bus of the flight control subsystem reserves a slave interface. When the subsystems are integrated, the master interface and the slave interface are connected to ensure the existence of the access channel. However, because of stringent timing requirement of on-chip AHB and AXI bus architecture, any abnormal signal transmitted across the buses is likely to shut down the flight control subsystem or the entire chip, thereby degrading the chip performance.

### SUMMARY

In accordance with the disclosure, there is provided a chip including a first subsystem and a second subsystem. The first subsystem includes a first system bus and a first interface of a peripheral bus. The first interface is connected with the first system bus. The second subsystem includes a second system bus and a second interface of the peripheral bus. The second interface is connected with the second system bus.

Also in accordance with the disclosure, there is provided a processor including a chip including a first subsystem and a second subsystem. The first subsystem includes a first system bus and a first interface of a peripheral bus. The first interface is connected with the first system bus. The second subsystem includes a second system bus and a second interface of the peripheral bus. The second interface is connected with the second system bus.

Also in accordance with the disclosure, there is provided a computer system including the above-described processor.

Also in accordance with the disclosure, there is provided a movable device including a power system and a chip. The chip includes a first subsystem and a second subsystem. The first subsystem includes a first system bus and a first interface of a peripheral bus. The first interface is connected with the first system bus. The second subsystem includes a second system bus and a second interface of the peripheral bus. The second interface is connected with the second system bus.

### BRIEF DESCRIPTION OF THE DRAWINGS

FIG. 1 is a schematic structural diagram of a multi-subsystem chip according to an example embodiment of the present disclosure.

FIG. 2 is a schematic structural diagram of a movable device according to an example embodiment of the present disclosure.

FIG. 3 is a schematic structural diagram of a multi-subsystem chip according to an example embodiment of the present disclosure.

FIG. 4 is a schematic structural diagram of a multi-subsystem chip according to another example embodiment of the present disclosure.

FIG. 5 is a schematic structural diagram of a computer system according to an example embodiment of the present disclosure.

FIG. 6 is a schematic structural diagram of a movable device according to another example embodiment of the present disclosure.

### DETAILED DESCRIPTION OF THE EMBODIMENTS

Embodiments of the present disclosure are described in detail below with reference to the accompanying drawings. Same or similar reference numerals in the drawings represent the same or similar elements or elements having the same or similar functions throughout the specification. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

Embodiments of the present disclosure are described in detail below with reference to the accompanying drawings. In the case of no conflict, the following embodiments and features of the embodiments can be combined with each other.

The technical solution of the present disclosure applies to a multi-subsystem chip. The multi-subsystem includes an application processor (AP) subsystem, a media subsystem, a communication subsystem, and a flight control subsystem, which are not limited by the present disclosure.

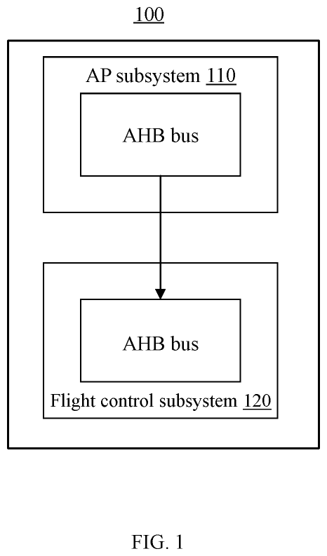

FIG. 1 is a schematic structural diagram of a multi-subsystem chip 100 according to an example embodiment of the present disclosure.

As shown in FIG. 1, the chip 100 includes an AP subsystem 110 and a flight control subsystem 120. The chip 100 may further include other subsystems not shown in FIG. 1. The AP subsystem 110 and the flight control subsystem 120 are used as examples for description. The AP subsystem 110 and the flight control subsystem 120 are configured in the chip 100. The interconnection and intercommunication between the AP subsystem 110 and the flight control system 120 are conducted through a system bus, such as an Advanced High Performance Bus (AHB) bus (shown in FIG. 1) or an Advanced eXtensible Interface (AXI) bus (not shown). The quantity of the AHB bus is not limited by the present disclosure. The quantity may be one and the AHB bus connects with the system bus and the system. The quantity may be more than one and the interfaces of the more than one AHB bus connects with multiple system buses, which are not limited by the present disclosure.

The AHB bus and the AXI bus have stringent timing requirement. That is, a succeeding operation is allowed to proceed only after a preceding operation is completed. Referring to FIG. 1, after the AP subsystem 110 sends a read operation instruction to the flight control subsystem 120, the flight control subsystem transmits corresponding data to the AP subsystem 110. After the data is transmitted successfully, the flight control subsystem 120 is allowed to proceed with a succeeding operation. If the AP subsystem 110 encounters a problem and needs to reset after the AP subsystem 110 sends the read operation instruction to the flight control subsystem 120, the data transmitted by the flight control subsystem 120 to the AP subsystem 110 will not be successfully received, thereby causing the flight control subsystem 120 unable to proceed with succeeding operations and hang.

In view of the above problem, the present disclosure provides an improved technical solution, in which the subsystems inside the chip are connected through a peripheral bus, such as a serial peripheral interface (SPI) bus, thereby avoiding hanging the subsystems.

The technical solution of the present disclosure also applies to various movable devices. The movable devices include an unmanned aerial vehicle, an unmanned boat, an autonomous vehicle, or a robot, which is not limited by the present disclosure.

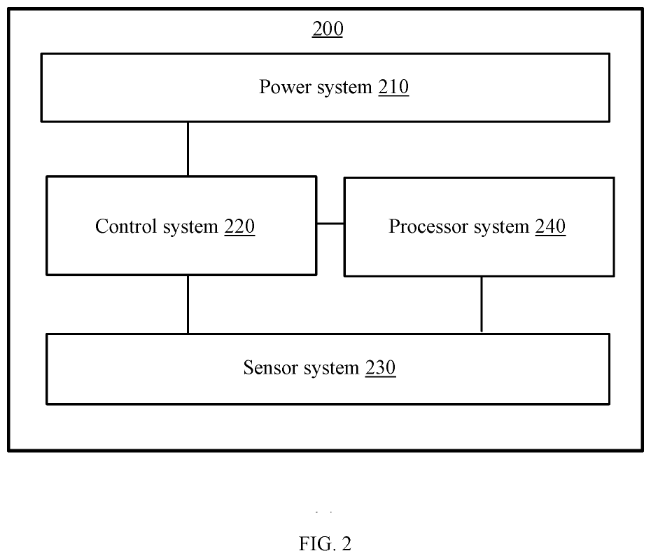

FIG. 2 is a schematic structural diagram of a movable device 200 according to an example embodiment of the present disclosure.

As shown in FIG. 2, the movable device 200 includes a power system 210, a control system 220, a sensor system 230, and a processor system 240.

The power system 210 supplies power to the movable device 200.

For example, the movable device 200 is an unmanned aerial vehicle (UAV). The power system of the UAV includes an electronic speed controller/regulator (ESC), a propeller, and an electric motor driving the propeller. The electric motor is connected between the ESC and the propeller. The electric motor and the propeller are disposed on a corresponding arm, The ESC receives a driving signal generated by the control system and supplies electric currents to the electric motor based on the driving signal to control a rotation speed of the electric motor. The electric motor drives the propeller to rotate, thereby supplying power for the UAV to fly.

The sensor system 230 measures attitude information of the movable device 200, that is, spatial position information and status information of the movable device 200, such as a three-dimensional (3D) position, a 3D angle, a 3D velocity, a 3D acceleration, and/or a 3D angular velocity. For example, the sensor system 230 may include at least one of a gyroscope, an electronic compass, an inertial measurement unit (IMU), a visual sensor, a global positioning system (GPS), a barometer, or an airspeed meter.

In some embodiments, the sensor system 230 may also be configured to obtain images. That is, the sensor system 230 includes a sensor for obtaining the images, such as a camera.

The control system 220 controls movement of the movable device 200. The control system 220 controls the movable device 200 based on pre-configured program instructions. For example, the control system 220 controls the movement of the movable device 200 based on the attitude information of the movable device 200 measured by the sensor system 230. The control system 220 may also control the movable device 200 according to a control signal from a remote controller. For example, at the UAV, the control system 220 may be a flight control system or a control circuit of the flight control system.

The processing system 240 processes the images obtained by the sensor system 230. For example, the processor system 240 may be a chip such as an image signal processor (ISP).

It should be understood that the above partition and naming of various components of the movable device 200 are merely exemplary and should not be construed as limiting the present disclosure.

The movable device 200 may also include other components not shown in FIG. 2, which will not be limited by the present disclosure.

In some embodiments, the control system 220 and the processor system 240 may be configured in the chip. That is, the control system 220 and the processor system 240 may be subsystems of the chip. The following technical solutions apply to the chip.

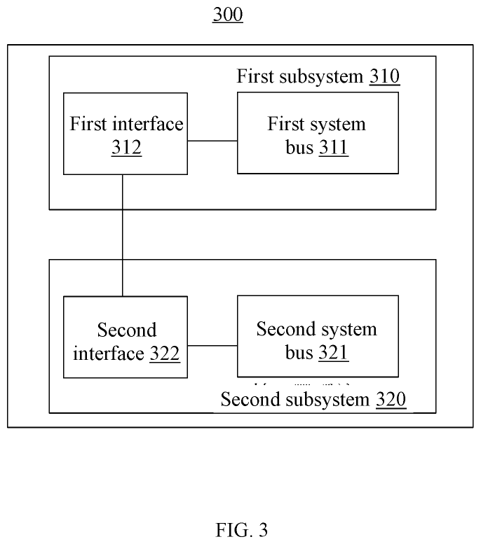

FIG. 3 is a schematic structural diagram of a multi-subsystem chip 300 according to an example embodiment of the present disclosure. The chip 300 includes multiple subsystems. As shown in FIG. 3, the chip 300 includes a first subsystem 301 and a second subsystem 320. But the present disclosure is not limited thereto.

A first system bus 311 and a first interface 312 of a peripheral bus are configured in the first subsystem 310 of the chip 300. The first interface 312 and the first system bus 311 are connected.

A second system bus 321 and a second interface 322 of the peripheral bus are configured in the second subsystem 320 of the chip 300. The second interface 322 and the second system bus 321 are connected.

In one example, the first system bus 311 connects with multiple system bus interfaces and connects with other subsystems of the chip 300 through the multiple system bus interfaces. Similarly, the second system bus 321 also connects with the multiple system bus interfaces and connects with the other subsystems of the chip 300 through the multiple system bus interfaces. In some embodiments, the first system bus 311 and the second system bus 321 also connect with peripheral bus interfaces. That is, the first system bus 311 connects with the first interface 312 of the peripheral bus and the second system bus 312 connects with the second interface 322 of the peripheral bus. As such, the first subsystem 310 and the second subsystem 320 communicate with each other through the peripheral bus including the first interface 312 and the second interface 322.

In one example, the first subsystem 310 accesses the first interface 312 through the first system bus 311 and the second subsystem 320 accesses the second interface 322 through the second system bus 322. Thus, the first subsystem 310 and the second subsystem 320 communicate with each other through the peripheral bus.

The first system bus 311 and the second system bus 321 may be the system bus for interconnections in the chip, such as the ANB bus or the AXI bus. But the present disclosure is not limited thereto.

The peripheral bus may be an SPI bus, an inter-integrated circuit (I²C) bus, or a universal receiver/transmitter (UART) bus. But the present disclosure is not limited thereto.

In some embodiments, the first system bus 311 and the second system bus 321 are not connected.

In other words, the first subsystem 310 and the second subsystem 320 are not directly connected through the system bus.

In this case, because the first subsystem 310 connects with the other subsystems through the system bus and the second subsystem 320 also connects with the other subsystems through the system bus, the first subsystem 310 and the second subsystem 320 are indirectly connected through the system bus.

In some embodiments, the first system bus 311 and the second system bus 321 are connected through the system bus.

In some embodiments, in addition to connecting to each other through the peripheral bus, the first system bus 311 and the second system bus 321 also connect to each other through the system bus. Some requests and subsequent interactions may be conducted through the system bus and some other requests and subsequent interactions may be conducted through the peripheral bus. For example, the requests and subsequent interactions from the first subsystem 310 to the second subsystem 320 are conducted through the system bus and the requests and subsequent interactions from the second subsystem 320 to the first subsystem 310 are conducted through the peripheral bus.

One of the two interfaces of the peripheral bus, that is, the first interface 312 and the second interface 322, is a master interface and the other is a slave interface. For example, the first interface 312 is the master interface, and the second interface 322 is the slave interface. In this case, the first interface 312 is configured to transmit the operation instruction of the first subsystem 310 to the second interface 322. That is, in the case that the first interface 312 is the master interface, the first interface 312 initiates an operation, and then the first interface 312 and the second interface 322 perform subsequent interactions.

In some embodiments, the first interface 312 is configured to receive first data of the first subsystem 310 and to transmit the first data to the second interface 322.

For example, under the circumstance that the first subsystem 310 writes the first data to the second subsystem 320, the first subsystem 310 transmits the first data to the first interface 312. The first interface 312 transmits the first data to the second interface 322 through the peripheral bus. The second subsystem 320 obtains the first data from the second interface 322. Thus, the process that the first subsystem 310 writes the first data to the second subsystem 320 is completed.

Under the circumstance that the transmission of the first data fails, for example, the second subsystem 320 hangs, because the first subsystem 310 stores the first data in the first interface 312, for example, in a buffer of the first interface 312, the first subsystem 310 may proceed to subsequent operations without hanging caused by the failed transmission of the first data.

In some embodiments, after the transmission of the first data from the first interface 312 to the second interface 322 fails, the first interface 312 transmits a first error indication signal to the first subsystem 310 and/or resets the first interface 212.

In one example, after the transmission of the first data to the second interface 322 fails, the first interface 312 transmits the first error indication signal to the first subsystem 310 to indicate the failed transmission of the first data. As such, the first subsystem 310 may re-transmit the first data. The first interface 312 may reset the first interface 312 to clear the first data stored in the first interface 312 and to facilitate the re-transmission of the first data by the first subsystem 310.

In some embodiments, the second interface 322 is configured to receive second data of the second subsystem 320, and to transmit the second data to the first interface 312.

For example, under the circumstance that the first subsystem 310 reads the second data from the second subsystem 320, the second subsystem 320 transmits the second data to the second interface 322. The second interface 322 transmits the second data to the first interface 312 through the peripheral bus. The first subsystem 310 obtains the second data from the first interface 312. Thus, the process that the first subsystem 310 reads the second data from the second subsystem 320 is completed.

Similarly, under the circumstance that the transmission of the second data fails, for example, the first subsystem 310 hangs, because the second subsystem 320 stores the second data in the second interface 322, for example, in a buffer of the second interface 322, the second subsystem 320 may proceed to subsequent operations without hanging caused by the failed transmission of the second data.

In some embodiments, after the transmission of the second data from the second interface 322 to the first interface 312 fails, the second interface 322 transmits a second error indication signal to the second subsystem 320 and/or resets the second interface 322.

In one example, after the transmission of the second data to the first interface 312 fails, the second interface 322 transmits the second error indication signal to the second subsystem 320 to indicate the failed transmission of the second data. As such, the second subsystem 320 may re-transmit the second data. The second interface 322 may reset the second interface 322 to clear the second data stored in the second interface 322 and to facilitate the re-transmission of the second data by the second subsystem 320.

In this case, for the interactions between the first subsystem 310 and the second subsystem 320, if only the first subsystem 310 needs to initiate the operation to the second subsystem 320, the first interface 312 can be configured to be the master interface and the second interface 322 can be configured to be the slave interface. Alternatively, if only the second subsystem 320 needs to initiate the operation to the first subsystem 310, the second interface 322 can be configured to be the master interface and the first interface 312 can be configured to be the slave interface. If both the first subsystem 310 and the second subsystem 320 need to initiate the operation, two pairs of the peripheral bus interfaces may be configured. One pair of the peripheral bus interfaces includes the master interface in the first subsystem 310 and another pair of the peripheral bus interfaces includes the master interface in the second subsystem 320. Alternatively, only one pair of the peripheral bus interfaces may be configured. Bidirectional operations are conducted in a system interruption mode.

One subsystem may connect with a plurality of subsystems through a plurality of peripheral buses, respectively. For example, the first subsystem 310 connects with a third subsystem through another peripheral bus similar to the peripheral bus between the first subsystem 310 and the second subsystem 320. For brevity, the description is omitted.

In the embodiments of the present disclosure, connection between the subsystems in the chip through the peripheral bus prevents the system bus from hanging caused by the timing requirement or caused by the hanging of the subsystem, thereby improving performance of the chip.

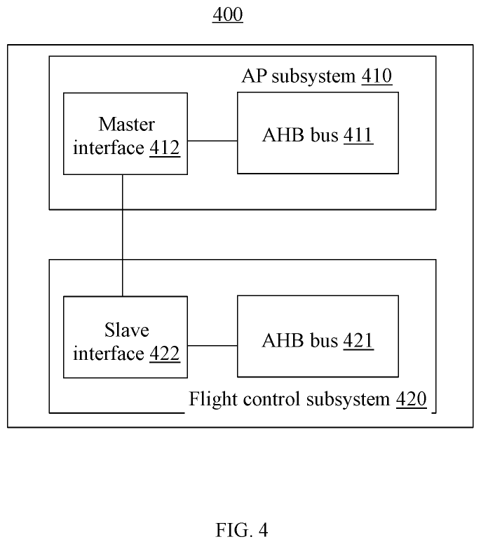

FIG. 4 is a schematic structural diagram of an example chip 400 consistent with the present disclosure.

As shown in FIG. 4, the chip 400 includes an AP subsystem 410 and a flight control subsystem 420. An AHB bus 411 of the AP subs-system 410 connects with a master interface 412 of an SPI bus. An AHB bus 421 of the flight control subsystem 420 connects with a slave interface 422 of the SPI bus. In this case, the AP subsystem 410 and the flight control subsystem 420 in the chip 400 are connected through the SPI bus. The AHB bus 411 of the AP subsystem 410 and the AHB bus 421 of the flight control subsystem 420 do not access to each other.

When the AP subsystem 410 communicates and the flight control subsystem 420 communicate with each other, the AP subsystem 410 accesses the master interface 412 of the SPI bus through the AHB bus 411, and the flight control subsystem 420 accesses the slave interface 422 of the SPI bus through the AHB bus 421.

For example, when the AP subsystem 410 reads data from the flight control subsystem 420, the AP subsystem 410 transmits a read operation instruction to the flight control subsystem 420 through the master interface 412. After the flight control subsystem 420 receives the read operation instruction, the flight control subsystem 420 transmits the data to the slave interface 422. For example, the data may be stored in a buffer of the salve interface 422. Then, according to the clock timing provided by the master interface 412, the slave interface 422 transmits the data to the master interface 412. The AP subsystem 410 obtains the data from the master interface 412.

If the communication between the master interface 412 and the slave interface 422 is abnormal due to some problems, either the master interface 412 or the slave interface 422 may be individually reset and the communication can be restarted without affecting the subsystems or the AHB buses. For example, if the AP subsystem 410 hands due to certain problem, and the master interface 412 also hangs logically, it will only affect the data transmission error of the slave interface 422 and it will not affect stability of the AHB bus 421, thereby unbale to cause the flight control subsystem 420 to hang.

Therefore, the embodiments of the present disclosure ensure that when other subsystems access the flight control subsystem, and the other subsystems hang due to certain problem, the flight control subsystem can still operate normally.

The present disclosure also provides a processor. The processor may include a chip consistent with the disclosure, such as one of the above-described example chips.

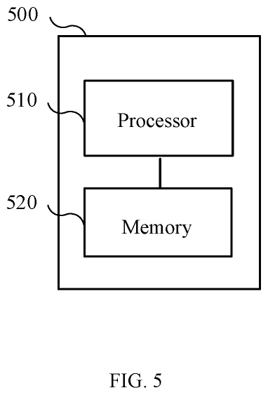

FIG. 5 is a schematic structural diagram of a computer system 500 according to an example embodiment of the present disclosure.

As shown in FIG. 5, the computer system 500 includes a processor 510 and a memory 520.

In some embodiments, the computer system 500 may also include components generally included in other computer systems, such as an input output device, a communication interface, etc., which is not limited by the present disclosure.

The memory 520 is configured to store computer executable instructions.

The memory 520 may include any type of memories, such as a high speed random access memory (RAM), or may include a non-volatile memory, such as at least one magnetic disk memory. The present disclosure is not limited thereto.

The processor 510 is configured to access the memory 520 and to execute the computer executable instructions.

In some embodiments, the processor 510 includes a chip consistent with the disclosure, such as one of the above-described example chips. In other words, the processor 510 includes a multi-subsystem chip consistent with the disclosure, such as one of the above-described example multi-subsystem chips.

The present disclosure also provides a movable device. The movable device includes a chip, a processor, or a computer system consistent with the disclosure, such as one of the above-described example chips, processors, or computer systems.

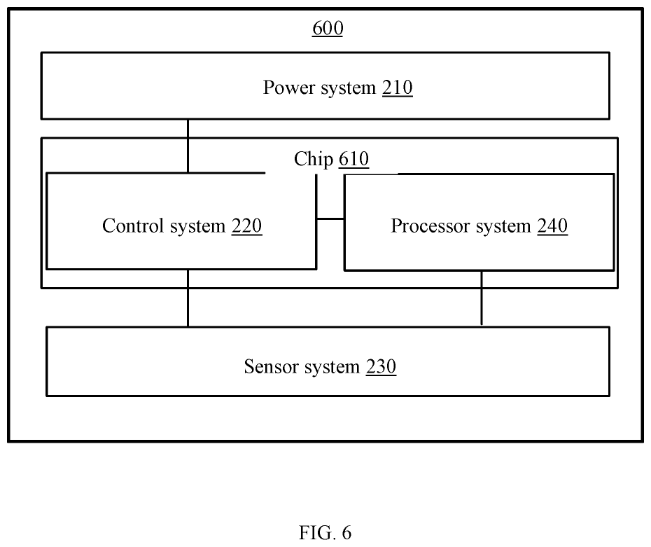

FIG. 6 is a schematic structural diagram of a movable device 600 according to another example embodiment of the present disclosure.

As shown in FIG. 6, the movable device 600 includes a chip 610. The chip 610 can be, e.g., one of the above-described example chips. The functions of the subsystems in the movable device 600 shown in FIG. 6 are similar to the functions of the subsystems in the movable device 200 shown in FIG. 2. The control system 220 and the processor system 240 are configured in the chip 610 consistent with embodiments of the present disclosure. The control system 220 and the processor system 240 may correspond to the first subsystem and the second subsystem in the above disclosed multi-subsystem chip, respectively. Thus, the control system 220 will not hang because the processor system 240 that accesses the control system 220 hangs, thereby ensuring normal movement of the movable device 600.

In the embodiments of the present disclosure, the term “and/or” is merely an association relationship describing associated objects, representing three relationships. For example, A and/or B may represent three cases of A alone, B alone, and both A and B. in addition, the character “/” in the specification often indicates that the associated objects have an “or” relationship.

Various embodiments of the present disclosure are used to illustrate the technical solution of the present disclosure, but the scope of the present disclosure is not limited thereto. Although the present disclosure has been described in detail with reference to the foregoing embodiments, those skilled in the art should understand that the technical solution described in the foregoing embodiments can still be modified or some or all technical features can be equivalently replaced. Without departing from the spirit and principles of the present disclosure, any modifications, equivalent substitutions, and improvements, etc. shall fall within the scope of the present disclosure. The scope of invention should be determined by the appended claims.

What is claimed is:

1. A chip comprising:
a first subsystem including a first system bus and a first interface of a peripheral bus, the first interface being connected with the first system bus; and
a second subsystem including a second system bus and a second interface of the peripheral bus, the second interface being connected with the second system bus.

2. The chip of claim 1, wherein:
the first subsystem is configured to access the first interface through the first system bus;
the second subsystem is configured to access the second interface through the second system bus; and
the first subsystem and the second subsystem are configured to communicate with each other through the peripheral bus.

3. The chip of claim 1, wherein the first system bus and the second system bus are not connected to each other.

4. The chip of claim 1, wherein the first system bus and the second system bus are connected to each other through a system bus.

5. The chip of claim 1, wherein the first interface is configured to transmit an operation instruction of the first subsystem to the second interface.

6. The chip of claim 1, wherein the first interface is configured to receive data of the first subsystem and to transmit the data to the second interface.

7. The chip of claim 6, wherein the first interface is further configured to, in response to failing to transmit the data to the second interface, perform at least one of:
transmitting an error indication signal to the first subsystem; or
resetting the first interface.

8. The chip of claim 1, wherein the second interface is configured to receive data of the second subsystem and to transmit the data to the first interface.

9. The chip of claim 8, wherein the second interface is further configured to, in response to failing to transmit the data to the first interface fails, perform at least one of:
transmitting an error indication signal to the second subsystem; or
resetting the second interface.

10. The chip of claim 1, wherein each of the first system bus and the second system bus includes an Advanced High Performance Bus (AHB) or an Advanced eXtensible Interface (AXI) bus.

11. The chip of claim 1, wherein the peripheral bus includes a serial peripheral interface (SPI) bus, an inter-integrated circuit (VC) bus, or a universal receiver/transmitter (UART) bus.

12. The chip of claim 1, wherein:
the first subsystem includes an application processor (AP) subsystem; and
the second subsystem includes a flight control subsystem.

13. The chip of claim 12, wherein the peripheral bus includes a serial peripheral interface (SPI) bus.

14. A processor comprising:
a chip including:
a first subsystem including a first system bus and a first interface of a peripheral bus, the first interface being connected with the first system bus; and
a second subsystem including a second system bus and a second interface of the peripheral bus, the second interface being connected with the second system bus.

15. A computer system comprising the processor of claim 14.

16. A movable device comprising:
a power system; and
a chip including:
a first subsystem including a first system bus and a first interface of a peripheral bus, the first interface being connected with the first system bus; and
a second subsystem including a second system bus and a second interface of the peripheral bus, the second interface being connected with the second system bus.
